(19) United States
(12) Patent Application Publication
(10) Pub. No.: US 2026/0277435 A1
(43) Pub. Date: Sep. 17, 2026

(54) HYBRID DATA STORAGE METHOD OF FLASH MEMORY AND STORAGE DEVICE USING THE HYBRID DATA STORAGE METHOD

(71) Applicant: INNODISK CORPORATION, New Taipei City (TW)

(72) Inventors: HUNG-PIN CHEN, New Taipei City (TW); HENG-AN LIAO, New Taipei City (TW)

(73) Assignee: INNODISK CORPORATION, New Taipei City (TW)

(21) Appl. No.: 19/180,178

(22) Filed: Apr. 16, 2025

(30) Foreign Application Priority Data
Mar. 17, 2025 (TW) 114109861

(51) Int. Cl. G06F 3/06; G06F 11/10

(52) U.S. Cl. CPC G06F 3/0608; G06F 3/0653; G06F 3/0679; G06F 11/1004

(57) ABSTRACT

A hybrid data storage method of a flash memory includes: using an X-level cell method to store data in at least one memory block of the flash memory; performing automatic error correction code on the at least one memory block to determine whether an error bit rate of at least one word line in the at least one memory block exceeds a threshold; when it is confirmed that the error bit rate exceeds the threshold, converting the data storage method corresponding to the at least one word line in the at least one memory block that meets that the error bit rate exceeds the threshold from the X-level cell method into a single-level cell method; and when it is confirmed that the error bit rate does not exceed the threshold, maintaining the data storage method corresponding to the at least one word line as the X-level cell method.

### CROSS-REFERENCE TO RELATED APPLICATION

This non-provisional application claims priority under 35 U.S.C. § 119(a) on Patent Application No. 114109861 filed in Taiwan, R.O.C. on March 17, 2025, the entire contents of which are hereby incorporated by reference.

### BACKGROUND OF THE INVENTION

### Field of the Invention

The present invention relates to a data storage method of a flash memory, and in particular, to a hybrid data storage method of a flash memory and a data storage device using the hybrid data storage method.

### Description of the Related Art

A solid-state drive (SSD) device is a data storage device manufactured with integrated circuits, and common SSD devices use a non-volatile memory as a main data storage element.

In recent years, the SSD devices are favored by users due to smaller size, more durable, lighter, more portable, noiseless, and faster access speed than traditional hard drives. However, as the memories in the SSD devices are subjected to repeated write or erase operations, the data storage capacity may be reduced, and even a storage data error may occur.

Therefore, it is common to mark blocks with questionable data storage capabilities as "bad blocks" through a memory block management method, so as to avoid a situation that data is stored in the abovementioned "bad blocks", which may cause errors in reading, writing, or erasing operations.

### BRIEF SUMMARY OF THE INVENTION

Since the entire block of a memory of an SSD device with questionable data storage capability is marked as a "bad block" in a memory management method, the SSD device may not use the abovementioned "bad block" to store data, which means that the entire block marked as a "bad block" can no longer be used. However, there are still other storage spaces (e.g., pages) that can be normally used in the "bad blocks", so the memory management method described above may have the problem of wasting available storage spaces of the memory.

To solve the problem above, an objective of the present invention is to provide a hybrid data storage method of a flash memory, which includes the following steps: using an X-level cell method to store data in at least one memory block of the flash memory; performing automatic error correction code (ECC) on the at least one memory block to determine whether an error bit rate of at least one word line in the at least one memory block exceeds a threshold; when it is confirmed that the error bit rate exceeds the threshold, converting the data storage method corresponding to the at least one word line in the at least one memory block that meets that the error bit rate exceeds the threshold from the X-level cell method into a single-level cell (SLC) method; and when it is confirmed that the error bit rate does not exceed the threshold, maintaining the data storage method corresponding to the at least one word line in the at least one memory block as the X-level cell method.

In one embodiment, after the step of when it is confirmed that the error bit rate exceeds the threshold, converting the data storage method corresponding to the at least one word line in the at least one memory block that meets that the error bit rate exceeds the threshold from the X-level cell method into a single-level cell method, the hybrid data storage method further includes a step of recording the word line corresponding to the single-level cell method in a word line management table.

In one embodiment, after the step of when it is confirmed that the error bit rate exceeds the threshold, converting the data storage method corresponding to the at least one word line in the at least one memory block that meets that the error bit rate exceeds the threshold from the X-level cell method into a single-level cell method, the at least one memory block includes a word line using the X-level cell method and a word line using the single-level cell method.

In one embodiment, the threshold is adjustable.

In one embodiment, the X-level cell method is a multilevel cell (MLC) method, a triple-level cell (TLC) method, a quad-level cell (QLC) method or a penta-level cell (PLC) method.

To solve the problem above, another objective of the present invention is to provide a data storage device using the hybrid data storage method, which includes a controller; a memory, electrically coupled to the controller and configured to store a firmware code; and a plurality of flash memories, electrically coupled to the controller and communicating with the controller. After the firmware code is executed by the controller, the following steps are performed: using an X-level cell method to store data in at least one memory block of the plurality of flash memories; performing automatic error correction code on the at least one memory block to determine whether an error bit rate of at least one word line in the at least one memory block exceeds a threshold; when it is confirmed that the error bit rate exceeds the threshold, converting the data storage method corresponding to the at least one word line in the at least one memory block that meets that the error bit rate exceeds the threshold from the X-level cell method into a single-level cell method; and when it is confirmed that the error bit rate does not exceed the threshold, maintaining the data storage method corresponding to the at least one word line in the at least one memory block as the X-level cell method.

In conclusion, according to the hybrid data storage method of the flash memory and the storage device using the hybrid data storage method in the present invention, the data storage method is checked and converted with the word line as the unit, and then the storage space utilization rate of each memory block in the data storage device is increased. In addition, the flash memory in the data storage device is dynamically managed through the hybrid data storage method, so that the purposes of elastically increasing the data access speed of part of the word lines (after converting into the single-level cell method), improving the durability of part of the word lines, and prolonging the service life of the data storage device are achieved.

### BRIEF DESCRIPTION OF THE DRAWINGS

FIG. 1 is a system block diagram of a data storage device according to an embodiment of the present invention.

FIG. 2 is a schematic diagram of a memory block according to an embodiment of the present invention.

FIG. 3 is a schematic diagram of a word line meeting that an error bit rate exceeds a threshold in a memory block according to an embodiment of the present invention.

FIG. 4 is another schematic diagram of a word line meeting that an error bit rate exceeds a threshold in a memory block according to an embodiment of the present invention.

FIG. 5 is a schematic diagram of a word line management table according to an embodiment of the present invention.

FIG. 6 is a flowchart of a hybrid data storage method according to an embodiment of the present invention.

FIG. 7 is a flowchart of a hybrid data storage method according to another embodiment of the present invention.

### DETAILED DESCRIPTION OF THE INVENTION

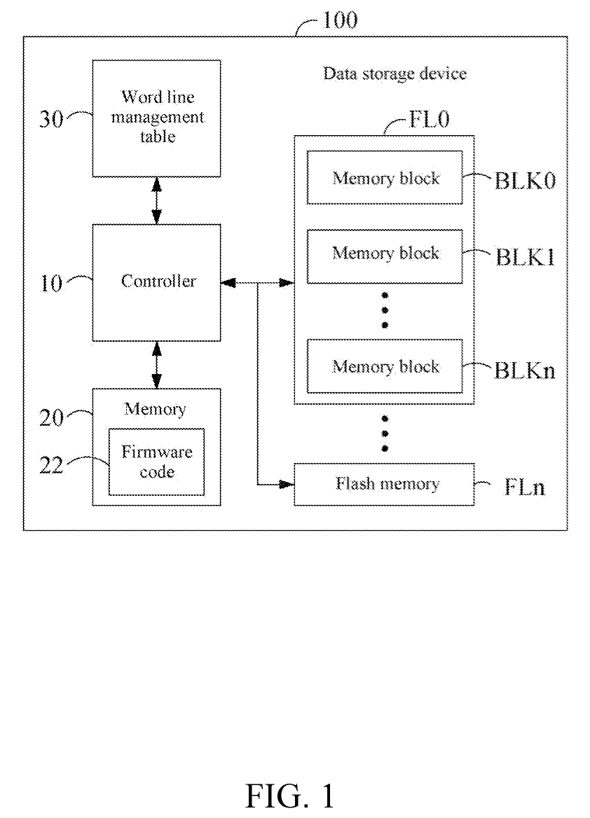

Referring to FIG. 1, which is a system block diagram of a data storage device 100 according to an embodiment of the present invention. As shown in FIG. 1, the data storage device 100 may include a controller 10, a memory 20 and n flash memories FL0-FLn, where n is a natural number greater than or equal to 1.

The controller 10 is configured to be electrically coupled to the flash memories FL0-FLn and communicate with the flash memories FL0-FLn. The controller 10 may control reading operation, writing operation and erasing operation of the flash memories FL0-FLn.

The memory 20 is electrically coupled to the controller 10. The memory 20 is configured to store a firmware code 22. The memory 20 may be composed of a non-volatile memory.

The firmware code 22 may be stored in the memory 20. In other embodiments, the firmware code 22 may also be stored in a memory (not shown in the figure) of the controller 10. After the firmware code 22 is executed by the controller 10, the following steps may be performed: an X-level cell method is used to store data in at least one of memory blocks BLK0-BLKn of the flash memories FL0-FLn; automatic error correction code is performed on the memory blocks BLK0-BLKn to determine whether an error bit rate of word lines in the memory blocks BLK0-BLKn exceeds a threshold; when it is confirmed that the error bit rate exceeds the threshold, the data storage method corresponding to the word lines in the memory blocks BLK0-BLKn that meet that the error bit rate exceeds the threshold is converted from the X-level cell method into a single-level cell method; and when it is confirmed that the error bit rate does not exceed the threshold, the data storage method corresponding to the word lines in the memory blocks BLK0-BLKn is maintained as the X-level cell method.

In addition, in this embodiment, the X-level cell method may be, for example, a multilevel cell method, a triple-level cell method, a quad-level cell method or a penta-level cell method, or an NAND technology of other higher-level cell methods. The multilevel cell method has a data access speed higher than that of the triple-level cell method, and the multilevel cell method has a data storage capacity lower than that of the triple-level cell method. The triple-level cell method has a data access speed higher than that of the quad-level cell method, and the triple-level cell method has a data storage capacity lower than that of the quad-level cell method. The quad-level cell method has a data access speed higher than that of the penta-level cell method, and the quad-level cell method has a data storage capacity lower than that of the penta-level cell method, and so on. That is, the X-level cell method has a data access speed higher than that of an X+1-level cell method, and the X-level cell method has a data storage capacity lower than that of the X+1-level cell method. In addition, the X-level cell method has a data access speed lower than that of the single-level cell method, and the X-level cell method has a data storage capacity higher than that of the single-level cell method.

That is, the single-level cell method has the highest data access speed compared with the X-level cell method. In addition, the single-level cell method may provide a cycle number of about 100,000 P/E, the multilevel cell method may provide a cycle number of about 10,000 P/E, the triple-level cell method may provide a cycle number of about 3,000 P/E, and the quad-level cell method may provide a cycle number of about 1,000 P/E. P refers to programming, and E refers to erasing. Therefore, the durability of the single-level cell method is superior to that of the X-level cell method, that is, the single-level cell method has the highest durability compared with the X-level cell method.

The flash memories FL0-FLn are electrically coupled to the controller 10. The flash memories FL0-FLn may communicate with the controller 10. The flash memories FL0-FLn are configured to be controlled by the controller 10 to perform the reading operation, the writing operation and the erasing operation of data. The flash memory FL0 has a plurality of memory blocks BLK0-BLKn, and so on, and each of the flash memories FL0-FLn has a plurality of memory blocks BLK0-BLKn.

In other embodiments, the data storage device 100 also has a word line management table 30. The word line management table 30 is connected to the controller 10. The word line management table 30 is configured to record relevant information of the word lines corresponding to the X-level cell method and the word lines corresponding to the single-level cell method. The controller 10 may control the flash memories FL0-FLn to perform the reading operation, the writing operation and the erasing operation in a specific data storage method through the relevant information provided by the word line management table 30.

In other embodiments, the word line management table 30 may be stored in the memory 20 and is connected to the controller 10 to provide the relevant information for the controller 10. In addition, after the step of when it is confirmed that the error bit rate exceeds the threshold, the data storage method corresponding to the word lines in the memory blocks BLK0-BLKn that meet that the error bit rate exceeds the threshold is converted from the X-level cell method into a single-level cell method, the memory blocks BLK0-BLKn include word lines using the X-level cell method and word lines using the single-level cell method, namely, a hybrid data storage method.

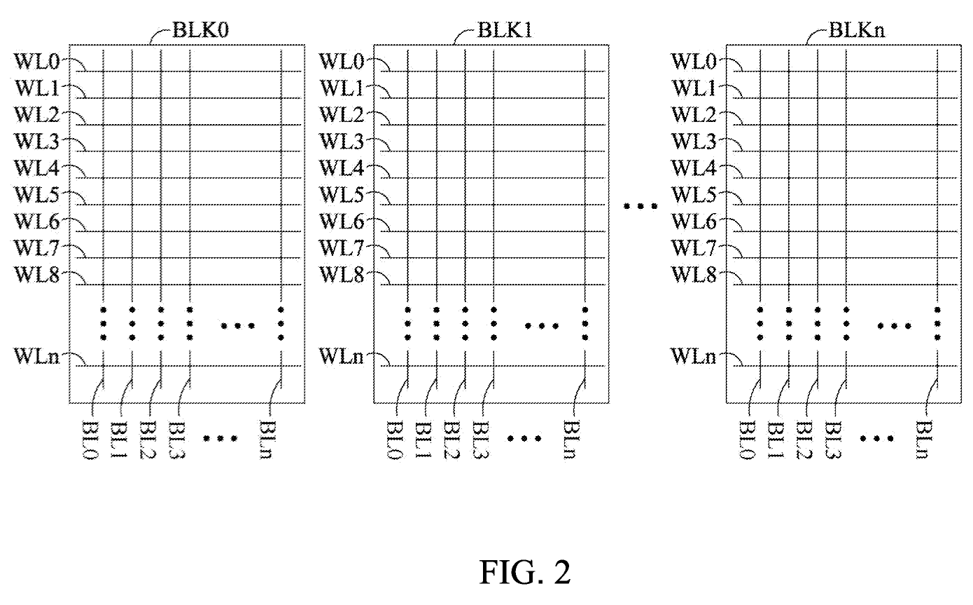

Referring to FIG. 2, which is a schematic diagram of memory blocks BLK0-BLKn according to an embodiment of the present invention. As shown in FIG. 2, each of the memory blocks BLK0-BLKn in the data storage device 100 includes a plurality of word lines WL0-WLn and a plurality of bit lines BL0-BLn. Areas in which the word lines WL0-WLn and the bit lines BL0-BLn are vertically crossed may form a plurality of memory units (not marked in the figure). The memory units are minimum structures used for accessing data.

In a preset data storage method of the data storage device 100, the memory blocks BLK0-BLKn may be configured to provide the same storage capacity, for example, the memory block BLK0 may provide a storage capacity Y0, the memory block BLK1 may provide a storage capacity Y0, …, and the memory block BLKn may provide a storage capacity Y0.

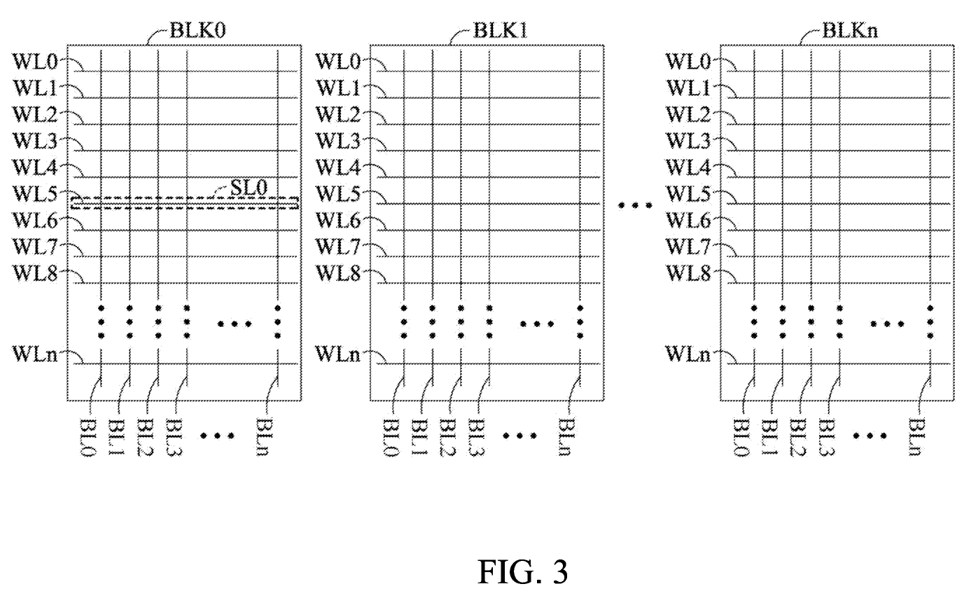

Referring to FIG. 3, which is a schematic diagram of a word line meeting that an error bit rate exceeds a threshold in memory blocks BLK0-BLKn according to an embodiment of the present invention. As shown in FIG. 3, after the memory blocks BLK0-BLKn execute the automatic error correction code, and confirm that the error bit rate (for example, 50.1%) of the word line WL5 in the memory block BLK0 exceeds the threshold (for example, 50%), the controller 10 may convert the data storage method corresponding to the word line WL5 that meets that the error bit rate exceeds the threshold in the memory block BLK0 from the X-level cell method into the single-level cell method. The word line WL5 may be marked as a word line SL0 with a high error bit rate. In other embodiments, the threshold may be set and adjusted by a user, namely the threshold is adjustable, and the threshold may be between 20% and 80% of the number of error correction bits, but is not limited thereto.

After the word line WL5 in the memory block BLK0 is marked as the word line SL0 with the high error bit rate, the memory block BLK0 may provide the storage capacity converted from the storage capacity Y0 to a storage capacity Y1, and the storage capacity Y1 is smaller than the storage capacity Y0. Because the memory blocks BLK1-BLKn do not have the word line that the error bit rate exceeds the threshold, the memory block BLK1 still provides the storage capacity Y0, …, and the memory block BLKn still provide the storage capacity Y0.

It is to be noted that part of memory units in the word line SL0 with high error bit rate may still be available, so that the word line SL0 with the high error bit rate in the memory block BLK0 may be continuously used for accessing data in the embodiment of the present invention; and compared with a memory management method in the prior art that after the whole block with questionable data storage capability in the memory of the SSD device is marked as a "bad block", the SSD device cannot use the "bad block" to store the data, the embodiment of the present invention has higher storage space utilization rate.

In addition, after the word line SL0 with the high error bit rate is converted from the X-level cell method into the single-level cell method, the overall data storage capacity of the word line SL0 with the high error bit rate is reduced, but the data access speed is obviously increased, and the durability is also improved.

In other words, according to the embodiment of the present invention, checking and converting are performed with the word line as the unit, thus the storage space utilization rate of the memory blocks BLK0-BLKn in the data storage device 100 is improved, the data access speed of part of the word lines (after converting into the single-level cell method) may be elastically improved, the durability of part of the word lines is improved, and the service life of the data storage device 100 is prolonged.

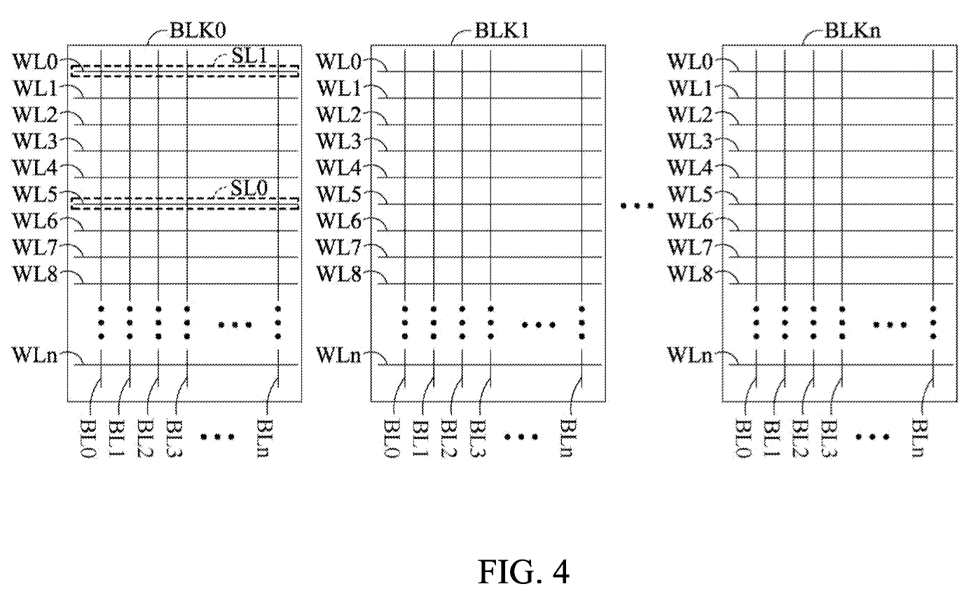

Referring to FIG. 4, which is another schematic diagram of word lines meeting that an error bit rate exceeds a threshold in memory blocks BLK0-BLKn according to an embodiment of the present invention. As shown in FIG. 4, after the memory blocks BLK0-BLKn execute the automatic error correction code and confirm that an error bit rate (for example, 50.1%) of a word line WL5 and an error bit rate (for example, 53%) of a word line WL0 in the memory block BLK0 exceed a threshold (for example, 50%), the controller 10 may convert the data storage method corresponding to the word line WL5 and the word line WL0 that meet that the error bit rate exceeds the threshold in the memory block BLK0 from the X-level cell method into the single-level cell method. The word line WL5 may be marked as a word line SL0 with a high error bit rate, and the word line WL0 may be marked as a word line SL1 with a high error bit rate.

After the word line WL5 in the memory block BLK0 is marked as the word line SL0 with the high error bit rate and the word line WL0 is marked as the word line SL1 with the high error bit rate, the memory block BLK0 may provide the storage capacity converted from the storage capacity Y0 to a storage capacity Y2, and the storage capacity Y2 is smaller than the storage capacity Y0. Because the memory blocks BLK1-BLKn do not have the word line that the error bit rate exceeds the threshold, the memory block BLK1 still provides the storage capacity Y0, …, and the memory block BLKn still provide the storage capacity Y0.

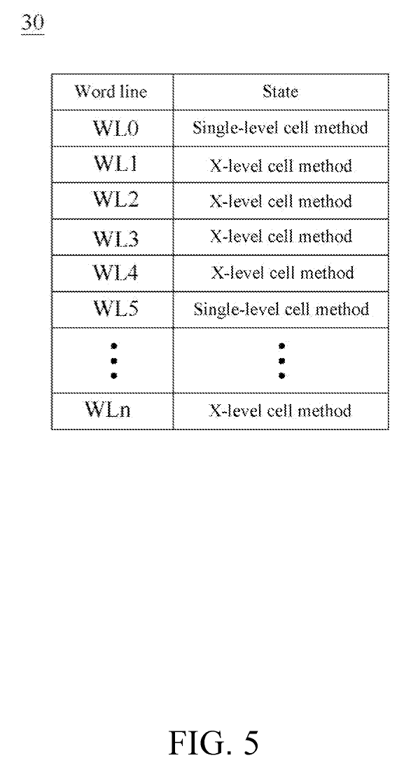

Referring to FIG. 5, which is a schematic diagram of a word line management table 30 according to an embodiment of the present invention. As shown in FIG. 5, the word line management table 30 may record the data storage methods used by word lines WL0-WLn in the memory blocks BLK0-BLKn. When the data storage method corresponding to the word line(s) that the error bit rate exceeds the threshold in the memory blocks BLK0-BLKn is converted from the X-level cell method into the single-level cell method, the controller 10 may update the word line management table 30 and control the data storage device 100 to operate according to the updated word line management table 30.

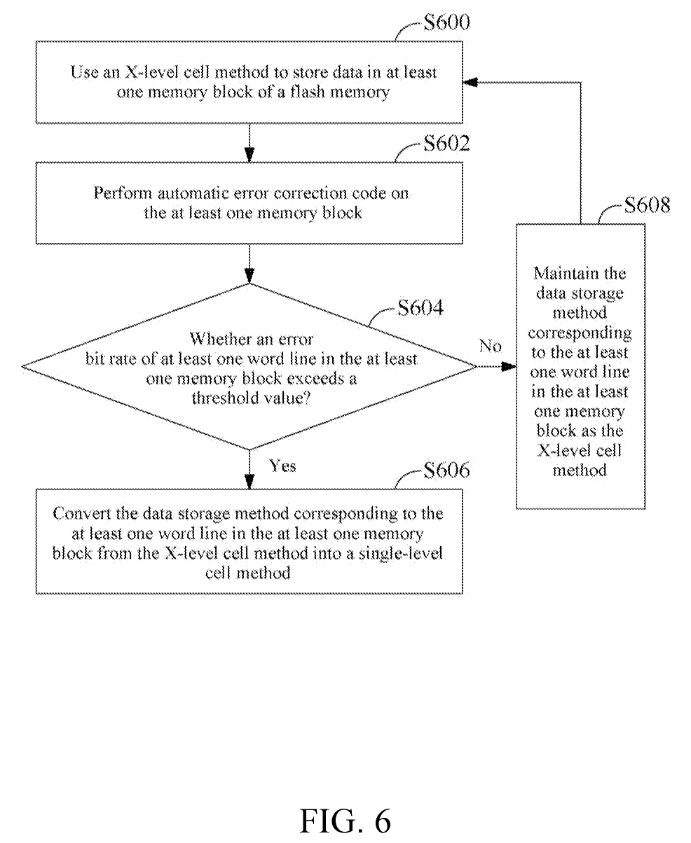

Referring to FIG. 6, which is a flowchart of a hybrid data storage method according to an embodiment of the present invention. As shown in FIG. 6, step S600: a controller 10 stores data in memory blocks BLK0-BLKn of flash memories FL0-FLn using an X-level cell method.

Step S602: the controller 10 performs automatic error correction code on the memory blocks BLK0-BLKn.

Step S604: whether an error bit rate of word lines WL0-WLn in the memory blocks BLK0-BLKn exceeds a threshold is determined. When it is determined as "not", step S608 is performed, and when it is determined as "yes", step S606 is performed.

Step S606: when it is confirmed that the error bit rate exceeds the threshold, the data storage method corresponding to the word lines WL0-WLn that meet that the error bit rate exceeds the threshold in the memory blocks BLK0-BLKn is converted from the X-level cell method into a single-level cell method.

Step S608: when it is confirmed that the error bit rate does not exceed the threshold, the data storage method corresponding to the word lines WL0-WLn in the memory blocks BLK0-BLKn is maintained as the X-level cell method, and the flow is returned to step S600.

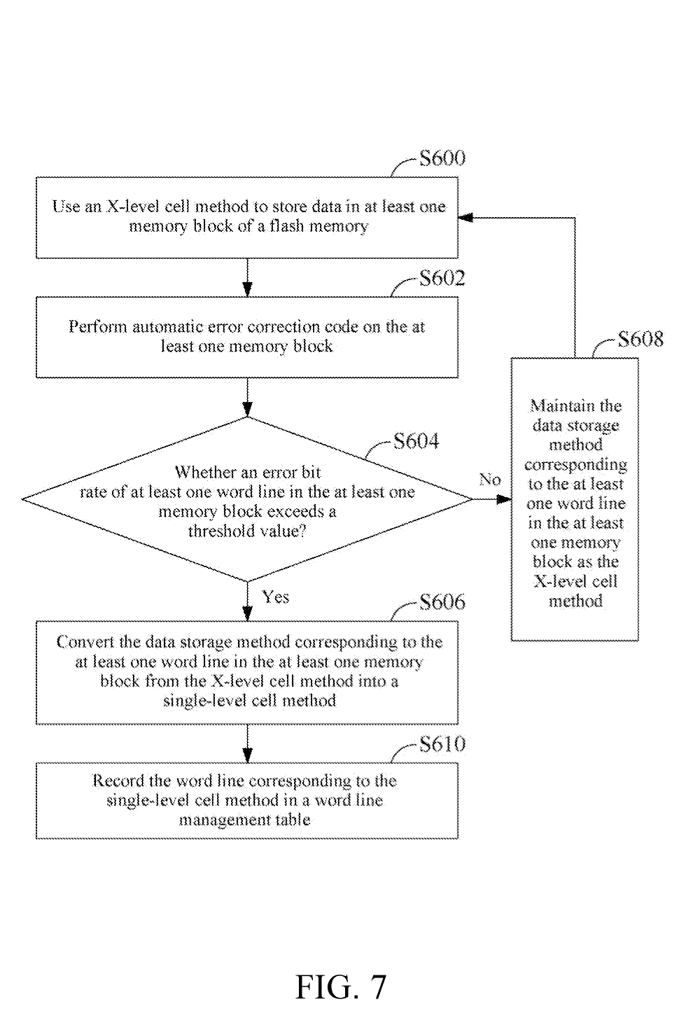

Referring to FIG. 7, which is a flowchart of a hybrid data storage method according to another embodiment of the present invention. The embodiment in FIG. 7 is different from the embodiment in FIG. 6 in that: after step S606 shown in FIG. 7, the method further includes a step S610, and the rest steps are the same as or similar to those shown in FIG. 6, which will not be repeated herein.

Step S610: the controller 10 records the word line(s) corresponding to the single-level cell method in the word line management table 30. Therefore, the controller 10 may control the data storage device 100 to perform reading operation, writing operation or erasing operation of data by updating the word line management table 30.

In conclusion, according to the hybrid data storage method of a flash memory and the storage device using the hybrid data storage method in the present invention, the data storage method is checked and converted with the word line as the unit, and then the storage space utilization rate of each memory block in the data storage device is increased. In addition, the flash memory in the data storage device is dynamically managed through the hybrid data storage method, so that the purposes of elastically increasing the data access speed of part of the word lines (after converting into the single-level cell method), improving the durability of part of the word lines, and prolonging the service life of the data storage device are achieved.

While the present disclosure has been described by means of specific embodiments, numerous modifications and variations could be made thereto by those skilled in the art without departing from the scope and spirit of the present disclosure set forth in the claims.

What is claimed is:

1. A hybrid data storage method of a flash memory, comprising the following steps:
using an X-level cell method to store data in at least one memory block of the flash memory;
performing automatic error correction code on the at least one memory block to determine whether an error bit rate of at least one word line in the at least one memory block exceeds a threshold;
when it is confirmed that the error bit rate exceeds the threshold, converting the data storage method corresponding to the at least one word line in the at least one memory block that meets that the error bit rate exceeds the threshold from the X-level cell method into a single-level cell method; and
when it is confirmed that the error bit rate does not exceed the threshold, maintaining the data storage method corresponding to the at least one word line in the at least one memory block as the X-level cell method.

2. The hybrid data storage method of the flash memory according to claim 1, wherein after the step of when it is confirmed that the error bit rate exceeds the threshold, converting the data storage method corresponding to the at least one word line in the at least one memory block that meets that the error bit rate exceeds the threshold from the X-level cell method into a single-level cell method, the hybrid data storage method further comprises a step of recording the word line corresponding to the single-level cell method in a word line management table.

3. The hybrid data storage method of the flash memory according to claim 1, wherein after the step of when it is confirmed that the error bit rate exceeds the threshold, converting the data storage method corresponding to the at least one word line in the at least one memory block that meets that the error bit rate exceeds the threshold from the X-level cell method into a single-level cell method, the at least one memory block comprises a word line using the X-level cell method and a word line using the single-level cell method.

4. The hybrid data storage method of the flash memory according to claim 1, wherein the threshold is adjustable.

5. The hybrid data storage method of the flash memory according to claim 1, wherein the X-level cell method is a multilevel cell method, a triple-level cell method, a quad-level cell method or a penta-level cell method.

6. A data storage device using a hybrid data storage method, comprising:
a controller;
a memory, electrically coupled to the controller and configured to store a firmware code; and
a plurality of flash memories, electrically coupled to the controller and communicating with the controller;
wherein after the firmware code is executed by the controller, the following steps are performed:
using an X-level cell method to store data in at least one memory block of the plurality of flash memories;
performing automatic error correction code on the at least one memory block to determine whether an error bit rate of at least one word line in the at least one memory block exceeds a threshold;
when it is confirmed that the error bit rate exceeds the threshold, converting the data storage method corresponding to the at least one word line in the at least one memory block that meets that the error bit rate exceeds the threshold from the X-level cell method into a single-level cell method; and
when it is confirmed that the error bit rate does not exceed the threshold, maintaining the data storage method corresponding to the at least one word line in the at least one memory block as the X-level cell method.

7. The data storage device using the hybrid data storage method according to claim 6, wherein after the step of when it is confirmed that the error bit rate exceeds the threshold, converting the data storage method corresponding to the at least one word line in the at least one memory block that meets that the error bit rate exceeds the threshold from the X-level cell method into a single-level cell method, the hybrid data storage method further comprises a step of recording the word line corresponding to the single-level cell method in a word line management table.

8. The data storage device using the hybrid data storage method according to claim 6, wherein after the step of when it is confirmed that the error bit rate exceeds the threshold, converting the data storage method corresponding to the at least one word line in the at least one memory block that meets that the error bit rate exceeds the threshold from the X-level cell method into a single-level cell method, the at least one memory block comprises a word line using the X-level cell method and a word line using the single-level cell method.

9. The data storage device using the hybrid data storage method according to claim 6, wherein the threshold is adjustable.

10. The data storage device using the hybrid data storage method according to claim 6, wherein the X-level cell method is a multilevel cell method, a triple-level cell method, a quad-level cell method or a penta-level cell method.
